(19) United States
(12) Patent Application Publication
(10) Pub. No.: US 2003/0101095 A1
(43) Pub. Date: May 29, 2003

(54) Advertisement inserting method and advertisement inserting service system

(75) Inventor: Kei Suzuki, Kanagawa (JP)

Correspondence Address: SUGHRUE MION, PLLC, 2100 PENNSYLVANIA AVENUE, N.W., WASHINGTON, DC, 20037, US

(73) Assignee: NEC INFRONTIA CORPORATION

(21) Appl. No.: 10/301,608

(22) Filed: Nov. 22, 2002

(30) Foreign Application Priority Data
Nov. 27, 2001 (JP) 2001-360363

(51) Int. Cl. G06F 17/60

(52) U.S. Cl. 705/14; 705/21

(57) ABSTRACT

An advertisement inserting service system of this invention provides a highly reliable advertisement inserting service. An advertisement inserting service system includes: a central terminal device providing advertisement reception information for publicizing insertion of an advertisement in a receipt to an advertiser terminal device through the Internet to thereby look for an advertiser, and receiving advertisement insertion requirements indicating desires of the advertiser applying for the insertion of the advertisement and advertisement data generated by the advertiser from the advertiser terminal device; server devices generating issuance instruction information for issuing a detailed instruction about the insertion of the advertisement based on the advertisement insertion requirements; and a POS terminal device printing out the advertisement data to the receipt based on the issuance instruction information when issuing the receipt.

### BACKGROUND OF THE INVENTION

1. Field of the Invention

The present invention relates to an advertisement inserting method and an advertisement inserting service system for inserting an advertisement in a receipt issued by a POS system.

2. Description of the Related Art

POS systems which print an advertisement on a receipt to be issued when a customer buys articles have been conventionally proposed (see, for example, Japanese Patent Unexamined Application Publication Nos. 2000-322654 and 2000-137754).

However, according to the POS system disclosed in the Japanese Patent Unexamined Application Publication No. 2000-322654, shop clerks are responsible for receiving advertisement insertion applications from advertisers, and inputting advertisement data and collecting advertisement fees, thereby forcing the clerks to carry out labour-intensive operations. The labour-intensive operations, in turn, may possibly lower the reliability of the advertisement inserting service.

In addition, the Japanese Patent Unexamined Application Publication No. 2000-137754 proposes a system for allowing a customer to select information acquired through the Internet or commercial information providing services and to print the information on a receipt free of charge. However, this system employs a method for allowing the customer to select information and to fetch advertisement data from the Internet, thereby printing the advertisement data every time a receipt is issued in POS operation for which immediacy is required, it disadvantageously takes time to print the receipt and the advertisement.

### SUMMARY OF THE INVENTION

The present invention has been achieved to solve the above-stated disadvantages. It is, therefore, an object of the present invention to provide an advertisement inserting method and an advertisement inserting service system capable of immediately printing out an advertisement-added receipt and capable of providing a highly reliable advertisement inserting service.

An advertisement inserting method according to the present invention executes the procedures of: providing advertisement reception information for publicizing insertion of an advertisement in a receipt to an advertiser terminal device through a communication network, and looking for an advertiser; receiving advertisement insertion requirements indicating desires of the advertiser applying for the insertion of the advertisement and advertisement data generated by the advertiser from the advertiser terminal device through the communication network, and generating issuance instruction information for issuing a detailed instruction about the insertion of the advertisement based on the advertisement insertion requirements; and transmitting the issuance instruction information and the advertisement data to a POS terminal device, and allowing the POS terminal device to print out the advertisement data to the receipt based on the issuance instruction information when issuing the receipt.

Further, one example of the constitution of the advertisement inserting method according to the present invention is such that a delivery target shop is decided on from a plurality of shops based on the advertisement insertion requirements, and that the issuance instruction information and the advertisement data are delivered to the POS terminal device of the decided delivery target shop.

Moreover, one example of the constitution of the advertisement inserting method according to the present invention is such that issuance progress information indicating an advertisement-added receipt issuance status is received from the POS terminal device, the issuance progress information is totalized, and a totalization result is transmitted to the advertiser terminal device which has provided the advertising data printed on the advertisement-added receipt.

Furthermore, one example of the constitution of the advertisement inserting method according to the present invention is such that registration status information indicating a registration status of the advertisement data is received from the POS terminal device, and the advertisement reception information showing possible advertisement data delivery target shops and POS terminal devices is updated based on the registration status information.

In addition, an advertisement inserting service system according to the present invention includes: a central terminal device (310) providing advertisement reception information for publicizing insertion of an advertisement in a receipt to an advertiser terminal device through a communication network to thereby look for an advertiser, and receiving advertisement insertion requirements indicating desires of the advertiser applying for the insertion of the advertisement and advertisement data generated by the advertiser from the advertiser terminal device; a server device (210, 230) receiving the advertisement insertion requirements and the advertisement data from the central terminal device, and generating issuance instruction information for issuing a detailed instruction about the insertion of the advertisement based on the advertisement insertion requirements; and a POS terminal device (110) receiving the issuance instruction information and the advertisement data from the server device, and printing out the advertisement data to the receipt based on the issuance instruction information when issuing the receipt.

Further, one example of the constitution of the advertisement inserting service system according to the present invention is such that the server device decides on a delivery target shop from a plurality of shops based on the advertisement insertion requirements, and delivers the issuance instruction information and the advertisement data to the POS terminal device of the decided delivery target shop.

Moreover, one example of the constitution of the advertisement inserting service system according to the present invention is such that the POS terminal device transmits issuance progress information indicating an advertisement-added receipt issuance status to the server device, the server device transfers the issuance progress information received from the POS terminal device to the central terminal device, and that the central terminal device totalizes the issuance progress information received from the server device, and transmits a totalization result to the advertiser terminal device providing the advertising data printed on the advertisement-added receipt.

Furthermore, one example of the constitution of the advertisement inserting service system according to the present invention is such that the POS terminal device transmits registration status information indicating a registration status of the advertisement data to the server device, the server device transfers the registration progress information received from the POS terminal device to the central terminal device, and that the central terminal device updates the advertisement reception information showing possible advertisement data delivery target shops and POS terminal devices based on the registration status information received from the server device.

### BRIEF DESCRIPTION OF THE DRAWINGS

FIG. 1 is a block diagram showing a configuration of an advertisement inserting service system in one embodiment according to the present invention;

FIG. 2 shows a system hierarchy of a POS terminal device in the embodiment according to the present invention; and

FIGS. 3A and 3B are sequence views showing an operation of the advertisement inserting service system shown in FIG. 1.

### DESCRIPTION OF THE PREFERRED EMBODIMENT

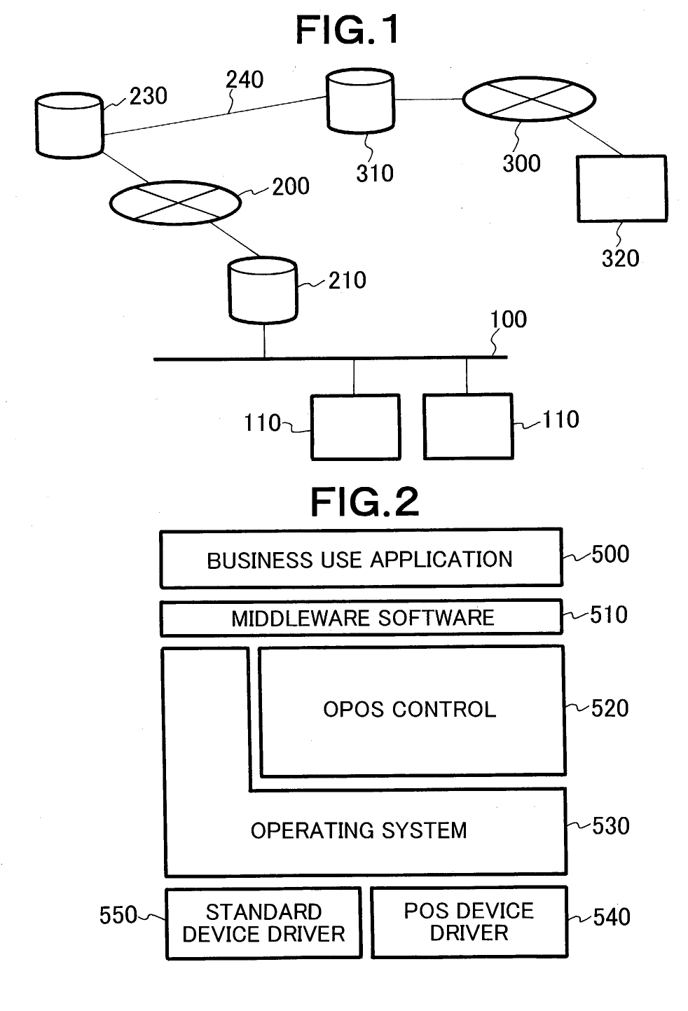

An embodiment of the present invention will be described hereinafter in detail with reference to the drawings. FIG. 1 is a block diagram showing a configuration of an advertisement inserting service system in one embodiment according to the present invention. The advertisement inserting service system in this embodiment consists of an advertiser terminal device 320, a central terminal device 310 managed by a retailer or an agency, the Internet 300 connecting the advertiser terminal device 320 to the central terminal device 310 mutually, a headquarters server device 230 disposed in the headquarters of the retailer, a network 240 connecting the headquarters server device 230 to the central terminal device 310 mutually, a shop server device 210 disposed every shop of the retailer, a network 200 such as ISDN (Integrated Service Digital Network) connecting the headquarters server device 230 to the shop server device 210 mutually and WAN (Wide Area Network), POS (Point of Sales) terminal devices 110 each disposed in the shop, and a network 100 such as LAN (Local Area Network) connecting the shop server device 210 to the POS terminal devices 110 mutually.

The advertiser terminal device 320 is an information processing system such as a personal computer. The advertiser terminal device 320 functions to access an advertisement reception website provided by the central terminal device 310 on the Internet 300, to receive advertisement reception information for explaining how to insert an advertisement in receipts and issuance progress information indicating a receipt issuance status from the central terminal device 310, and to display these pieces of information on the screen of the device 320. The advertiser terminal device 320 also functions to transmit advertisement insertion requirements showing conditions set by an advertiser for inserting an advertisement and advertisement image data (to be referred to as “advertisement data” hereinafter) to be printed on each receipt, to the central terminal device 310 through the Internet 300.

The central terminal device 310 consists of an information processing system such as a server, and managed by a retailer or an agency. Alternatively, a WWW (Word Wide Web) server space managed by a provider or the like may be employed as the central terminal device 310. If the agency manages the central terminal device 310, it is possible to insert many pieces of retailer information and accept many advertisement insertion applications.

The central terminal device 310 functions to receive the advertisement insertion requirements and the advertisement data transmitted from the advertiser terminal device 320 by the operation of the advertiser, to generate advertisement registration completion information, and to transmit the generated information to the advertiser terminal device 320. The central terminal device 310 also functions to totalize issuance progress information from the POS terminal device 110, and to transmit information indicating the totalization result or advertisement insertion completion to the advertiser terminal device 320. The central terminal device 310 further functions to settle an advertisement account on credit with a credit card company to charge an advertisement fee to the advertiser.

The retailer headquarters server device 230 receives the advertisement insertion requirements and the advertisement data from the central terminal device 310 through the network 240. The headquarters server device 230 generates issuance instruction information for giving a detailed instruction about the insertion of an advertisement in receipts to the POS terminal devices 110 based on the advertisement insertion requirements, and decides on a delivery target shop to which the advertisement data is delivered based on the advertisement insertion requirements. After deciding on the shop, the headquarters server device 230 transmits the advertisement data and the generated issuance instruction information to the shop server device 210 of the delivery target shop through the network 200. In addition, the headquarters server device 230 functions to receive and manage registration status information as to how many pieces of advertisement data are registered in the POS terminal devices 110 and the issuance progress information from the shop server device 210, and to transmit the information to the central terminal device 310.

The shop server device 210 delivers the issuance instruction information and the advertisement data received from the headquarters server device 230 to the POS terminal devices 110 provided in the shop through the network 100. The shop server device 210 also functions to transmit the registration status information and the issuance progress information on the respective terminal devices received from the POS terminal devices 110 to the headquarters server device 230.

Each POS terminal device 110 stores the received advertisement data and issuance instruction information in a hard disk device or a memory, adds the advertisement data to print data based on the issuance instruction information, and transfers the advertisement data-added print data to a receipt printer to print out receipts when issuing the receipts. Further, the POS terminal device 110 can hold a plurality of pieces of advertisement issuance instruction information and advertisement data, and print out different advertisements whenever a receipt is issued. In addition, the POS terminal device 110 functions to transmit the registration status information and the issuance progress information to the shop server device 210 in real time.

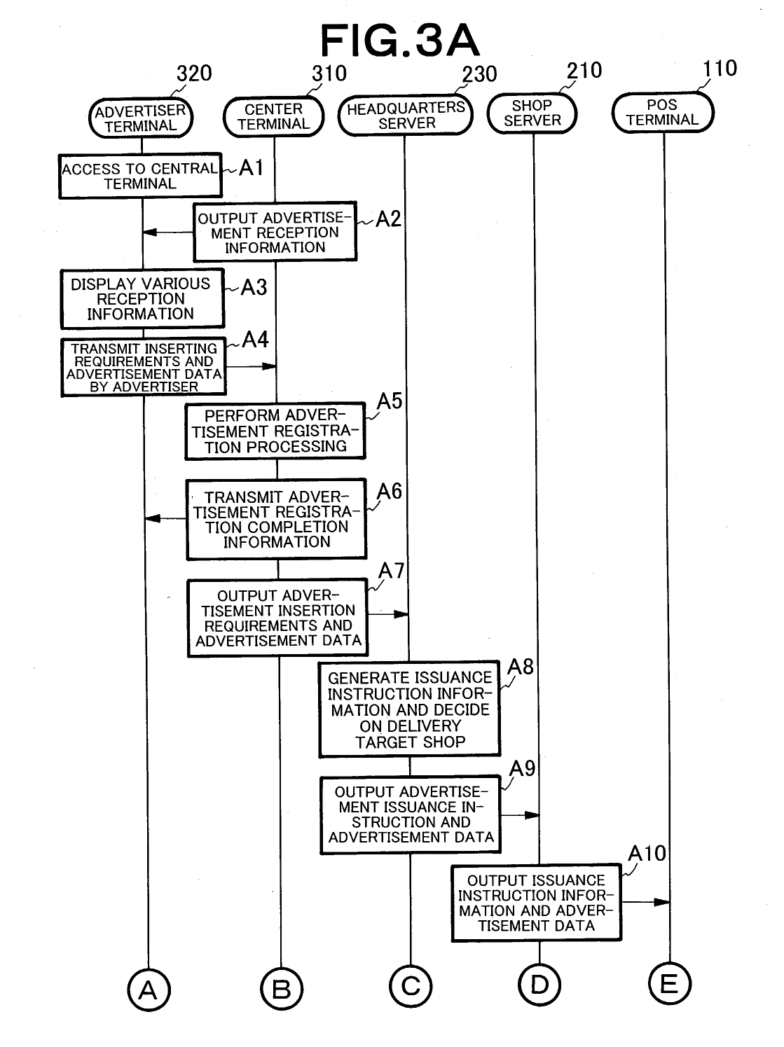

FIG. 2 shows the system hierarchy of the POS terminal device 110. The system hierarchy of an ordinary POS terminal device is such that a business use application 500, a middleware software 510, an OPOS (OLE for Point of Sales) control 520, an operating system 530, a POS device driver 540, and a standard device driver 550 are hierarchically provided in descending order.

The advertisement issuance application of the present invention is provided as the middleware software 510. By doing so, the advertisement issuance application in connection with the business use application 500 can add the advertisement to receipts, manage the advertisement registration status, manage the issuance progress information and transmit/receive data to/from the shop server device 210. Further, if the advertisement issuance application function is given to the lower hierarchies of the OPOS control 520 and the POS device driver 540, it is possible to conceal higher-level data and to perform advertisement insertion operation in greater security.

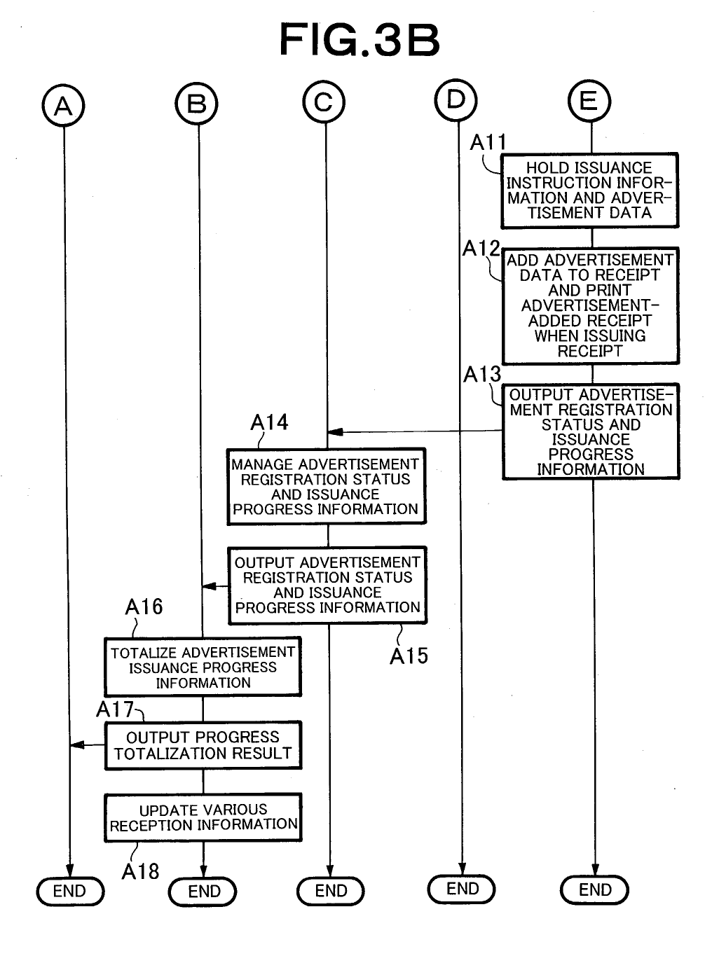

Referring next to FIGS. 1 and 3, the operation of the advertisement inserting service system in this embodiment will be described in more detail. FIGS. 3A and 3B are sequence views showing the operation of the advertisement inserting service system in this embodiment. First, the advertiser operates the advertiser terminal device 320, and accesses the website (advertisement reception website) of the central terminal device managed by the retailer or agency from the advertiser terminal device 320 through the Internet 300 (in a step A1).

In accordance with this access, the central terminal device 310 transmits the files of the website which presents the advertisement reception information to the advertiser to the advertiser terminal device 320 through the Internet 300 (in a step A2). As a result, the advertisement reception information is displayed on the screen of the advertiser terminal device 320 (in a step A3).

The advertisement reception information includes the explanation of how to insert an advertisement, that of procedures for inserting the advertisement, that of the scale of retailers providing the advertisement to customers, that of a region in which the retailers do sales activities, that of an advertisement fee for each of various agreement methods, that of an advertisement data generation method, that of generation criterion and the like.

Based on the advertisement reception information, the advertiser generates advertisement data and sets advertisement insertion requirements. The advertisement insertion requirements differ according to the scale of retailers. If the retailer is a large-scale retailer, it is possible to set detailed conditions including those for the shop to which the advertisement are provided, an advertisement insertion period, and the issuance number of advertisement-added receipts and the like. If the retailer is a small-scale retailer, it is possible to set, as advertisement insertion requirements, conditions to such an extent as to include an advertisement insertion period, the issuance number of advertisement-added receipts and the like.

After setting the conditions, the advertiser transmits the advertisement data and the advertisement insertion requirements to the central terminal device 310 from the advertiser terminal device 320 through the Internet (in a step A4). On the website on which the generated advertisement data is registered and the advertisement insertion requirements are set, a “registration” button which is created by CGI (Common Gateway Interface), ASP (Active Server Pages) or the like is displayed. The advertiser can easily transmit the advertisement data and the advertisement insertion requirements only by clicking this “registration” button.

Next, when receiving the advertisement data and the advertisement insertion requirements through the Internet 300, the central terminal device 310 performs an advertisement registration processing for storing the received advertisement data and advertisement insertion requirements in an internal storage device, not shown, (in a step A5), and transmits advertisement registration completion information indicating that advertisement registration is completed to the advertiser terminal device 320 (in a step A6). The advertiser, who views the advertisement registration completion information displayed on the screen of the advertiser terminal device 320, can know that the reception of advertisement insertion is completed.

The central terminal device 310 outputs the advertisement data and the advertisement insertion requirements to the headquarters server device 230 through the network 240 (in a step A7). The headquarters server device 230 creates issuance instruction information based on the received advertisement insertion requirements, and decides on a delivery target shop to which the advertisement data is delivered based on the advertisement insertion requirements (in a step A8). The issuance instruction information includes detailed instruction information such as the number of POS terminal devices 110 which issue advertisement-added receipts and the issuance frequency of advertisement-added receipts.

The headquarters server device 230 transmits the advertisement data and the created issuance instruction information to the shop server device 210 of the delivery target shop through the network 200 (in a step A9). The shop server device 210 of the delivery target shop outputs the received advertisement data and the issuance instruction information to the POS terminal devices 110 which actually issue advertisement-added receipts and the number of which is designated by the issuance instruction information (in a step A10).

The flow from the steps A8 to A10 can be realized by the same method as that for delivering PLU (Price Look Up) data and moving picture data displayed on the screens which are well known in the conventional POS system to the respective POS terminal devices 110, and can be updated daily or at appropriate timings.

Next, each POS terminal device 110 stores the received advertisement data and issuance instruction information to a storage device (not shown) such as a hard disk device or a memory (in a step A11). The POS terminal device 110 prints accounting information such as the names, prices, volume and total amounts of money of products which each customer bought and the amount of changes, on a receipt by a receipt printer. When issuing the receipt, the POS terminal device 110 combines the accounting information data with the advertisement data in a predetermined format to generate print data, prints out this print data to the receipt, and thereby issues the receipt with the advertisement instructed by the issuance instruction information (in a step A12).

Further, by transferring and holding the delivered advertisement data to and in the receipt printer portion of each POS terminal device 110, it is possible to reduce transfer time required whenever a receipt is printed.

If a plurality of pieces of advertisement data are registered, each POS terminal device 110 prints the respective pieces of advertisement data in accordance with the issuance frequency instructed by the issuance instruction information corresponding to the respective pieces of advertisement data.

Next, each POS terminal device 110 outputs the registration status information indicating how many types of advertisement data are registered and the issuance progress information indicating the status of the issuance of advertisement-added receipts, to the headquarters server device 230 through the shop server device 210 (in a step A13). The headquarters server device 230 stores the registration status information and the issuance progress information on the respective POS terminal devices 110 in an internal storage device, not shown, and manages the information (in a step A14). The registration status information is used as data for next advertisement delivery. The flow from the step A13 to the step A14 can be realized by the same method as that for fetching sales data from the respective POS terminal devices 110 into the headquarters server device 230 and totalizing the sales data.

Next, the headquarters server device 230 outputs the registration status information and the issuance progress information on the respective POS terminal devices 110 to the central terminal device 310 (in a step A15). The central terminal device 310 totalizes the issuance progress information received from the headquarters server device 230 (in a step A16), and transmits a totalization result indicating the issuance number of advertisement-added receipts to the advertiser terminal device 320 (in a step A17).

Then, the central terminal device 310 decides on a shop which may be a delivery target of the advertisement data and the number of the POS terminal devices 110 thereof based on the registration status information on the respective POS terminal devices 110, and updates the advertisement reception information presented on the website (in a step A18). In this advertisement reception information update processing, if many pieces of advertisement data are registered in the POS terminal devices 110 of a certain shop, for example, it is determined that it is unsuited for the certain shop to deliver new advertisement data and this shop is excluded from the possible delivery targets.

According to this embodiment, the advertiser can add an advertisement to receipts as if the advertiser carries a banner advertisement in the Internet, mail magazines or the like. Since the advertisement inserted in the receipts is attractive, the advertisement has a higher effect than that by other advertising methods. If multicolor receipts are used, the advertising effect is greater. This is because the advertisement data received through the Internet is added to and printed on receipts based on the set advertisement insertion requirements.

Further, according to this embodiment, it is possible to easily introduce multicolor to receipts. By using multicolor receipts, it is possible to differentiate the advertisement from those of other companies. The reason is as follows. Although the use of multicolor receipts pushes up running cost, the cost can be paid by an advertising revenue gained by realizing colorful advertisement expression.

In this embodiment, the shop server device 210 is provided. Depending on the system, the network 200 is sometimes directly connected to the POS terminal devices 110. In this case, the headquarters server device 230 also acts as the shop server device 210.

According to the present invention, advertisement reception information for publicizing insertion of an advertisement in a receipt is provided to an advertiser terminal device through a communication network, advertisement insertion requirements indicating desires of the advertiser applying for the insertion of the advertisement and advertisement data generated by the advertiser are received from the advertiser terminal device through the communication network, issuance instruction information for issuing a detailed instruction about the insertion of the advertisement is generated based on the advertisement insertion requirements, and the POS terminal device prints out the advertisement data to the receipt based on the issuance instruction information when issuing the receipt. Therefore, it is possible to easily, assuredly perform operations for looking for an advertiser, receiving an advertisement insertion application from the advertiser, receiving advertisement data and delivering the advertisement data to POS terminal devices, to issuing the advertisement based on the advertisement insertion requirements, without bothering clerks, and to provide a highly reliable advertisement inserting service. Since the advertisement can be created using image data, the creation of the advertisement does not cause any problem in present situations in which banner advertisements are widely spread. Further, by printing the advertisement data registered in the POS terminal devices on receipts based on the issuance instruction information, an advertisement delivery method and an advertisement issuance method suited for the utilization of POS are realized. It is, therefore, possible to immediately print out an advertisement-added receipt. In addition, clerks are unable to view the advertisement issuance status and to change or manipulate the issuance instruction information, thereby making it possible to enhance security.

Furthermore, issuance progress information indicating an advertisement-added receipt issuance status is received from the POS terminal device, the issuance progress information is totalized, and a totalization result is transmitted to the advertiser terminal device which is a provider of the advertising data printed on the advertisement-added receipt. Therefore, the retailer can surely gain an advertisement revenue. The reason is as follows. It is possible to connect an advertiser to a retailer which have no business dealings therebetween. The advertisement issuance processing and the issuance program management are performed between the server device and POS terminal devices of the retailer and the central terminal device, and it is ensured that the advertiser is informed of the issuance progress information. It is, therefore, possible to provide a highly reliable service and to thereby manage an independent advertisement inserting service. If the retailer can manage the highly reliable advertisement inserting service, the retailer can earn profits, which is substantiated by the fact that banner advertisements carried on the Internet, mail magazines and the like attract much attention.

What is claimed is:

1. An advertisement inserting method comprising the steps of:
providing advertisement reception information for publicizing insertion of an advertisement in a receipt to an advertiser terminal device through a communication network, and looking for an advertiser;
receiving advertisement insertion requirements indicating desires of the advertiser applying for the insertion of the advertisement and advertisement data generated by the advertiser from the advertiser terminal device through the communication network, and generating issuance instruction information for issuing a detailed instruction about the insertion of the advertisement based on the advertisement insertion requirements; and
transmitting the issuance instruction information and the advertisement data to a POS terminal device, and allowing the POS terminal device to print out the advertisement data to the receipt based on the issuance instruction information when issuing the receipt.

2. An advertisement inserting method according to claim 1, further comprising the step of:
deciding on a delivery target shop from a plurality of shops based on the advertisement insertion requirements, and delivering the issuance instruction information and the advertisement data to the POS terminal device of the decided delivery target shop.

3. An advertisement inserting method according to claim 1, further comprising the step of:
receiving issuance progress information indicating an advertisement-added receipt issuance status from the POS terminal device, totalizing the issuance progress information, and transmitting a totalization result to the advertiser terminal device providing the advertising data printed on the advertisement-added receipt.

4. An advertisement inserting method according to claim 1, further comprising the step of:
receiving registration status information indicating a registration status of the advertisement data from the POS terminal device, and updating the advertisement reception information showing possible advertisement data delivery target shops and POS terminal devices based on the registration status information.

5. An advertisement inserting service system comprising:
a central terminal device providing advertisement reception information for publicizing insertion of an advertisement in a receipt to an advertiser terminal device through a communication network to thereby look for an advertiser, and receiving advertisement insertion requirements indicating desires of the advertiser applying for the insertion of the advertisement and advertisement data generated by the advertiser from the advertiser terminal device;
a server device receiving the advertisement insertion requirements and the advertisement data from the central terminal device, and generating issuance instruction information for issuing a detailed instruction about the insertion of the advertisement based on the advertisement insertion requirements; and
a POS terminal device receiving the issuance instruction information and the advertisement data from the server device, and printing out the advertisement data to the receipt based on the issuance instruction information when issuing the receipt.

6. An advertisement inserting service system according to claim 5, wherein
the server device decides on a delivery target shop from a plurality of shops based on the advertisement insertion requirements, and delivers the issuance instruction information and the advertisement data to the POS terminal device of the decided delivery target shop.

7. An advertisement inserting service system according to claim 5, wherein
the POS terminal device transmits issuance progress information indicating an advertisement-added receipt issuance status, to the server device,
the server device transfers the issuance progress information received from the POS terminal device to the central terminal device, and
the central terminal device totalizes the issuance progress information received from the server device and transmits a totalization result to the advertiser terminal device which is a provider of the advertising data printed on the advertisement-added receipt.

8. An advertisement inserting service system according to claim 5, wherein
the POS terminal device transmits registration status information indicating a registration status of the advertisement data to the server device,
the server device transfers the registration progress information received from the POS terminal device to the central terminal device, and
the central terminal device updates the advertisement reception information showing possible advertisement data delivery target shops and POS terminal devices based on the registration status information received from the server device.
